(19) United States
(12) Patent Application Publication
(10) Pub. No.: US 2017/0274320 A1
(43) Pub. Date: Sep. 28, 2017

(54) HONEYCOMB FILTER

(71) Applicant: NGK INSULATORS, LTD., Nagoya-City (JP)

(72) Inventor: Narimasa SHINODA, Nagoya-City (JP)

(73) Assignee: NGK INSULATORS, LTD., Nagoya-City (JP)

(21) Appl. No.: 15/458,102

(22) Filed: Mar. 14, 2017

(30) Foreign Application Priority Data
Mar. 24, 2016 (JP) 2016-060787

(51) Int. Cl. B01D 53/94; B01J 35/04; B01J 21/08; B01J 21/06; B01J 23/78; B01D 46/24; B01J 27/224

(52) U.S. Cl. CPC B01D 53/944; B01D 46/2459; B01J 35/04; B01J 27/224; B01J 21/06; B01J 23/78; B01J 21/08; B01D 2046/2481; B01D 2046/2488; B01D 2255/915

(57) ABSTRACT

A honeycomb filter includes a honeycomb structure body having porous partition walls defining a plurality of cells which become through channels for fluid, plugging portions disposed in open ends of the cells, and a protective layer disposed to cover at least the surface of the honeycomb structure body, each of the honeycomb structure body and the plugging portion has a structure constituted of aggregates made of silicon carbide and a bonding material which bonds the aggregates to one another, the protective layer is a layer in which silicon is present as much as 40 mass % or more and oxygen is present as much as 40 mass % or more and a thickness is 0.5 μm or more, and an outer end face of both end faces of the plugging portion has an exposed region in which the protective layer is not disposed.

### BACKGROUND OF THE INVENTION

Field of the Invention

The present invention relates to a honeycomb filter, and more particularly, it relates to a honeycomb filter in which it is detectable that an inner portion has reached a high temperature and in which generation of end face cracks is inhibited.

Description of the Related Art

For the purpose of trapping dust and another particulate matter included in exhaust gases from cars, incineration exhaust gases to be generated during incineration of wastes, and the like, honeycomb filters constituted of ceramic honeycomb filters have been used in the cars and the like. Especially for the purpose of efficiently removing particulate matter (hereinafter also referred to as “PM”) such as soot emitted from an internal combustion engine, a diesel particulate filter (hereinafter also referred to as “DPF”) has been used.

As this diesel particulate filter, there is known a honeycomb filter constituted of a bonded body in which outer walls of a plurality of honeycomb segments are bonded to one another with a bonding material, or the like (e.g., see Patent Document 1).

Furthermore, this DPF is finally clogged when the trapped PM is not removed, and hence it is necessary to remove the trapped PM and regenerate the filter. An example of the regeneration of the DPF is a method of burning the PM.

[Patent Document 1] JP-A-2000-279729

### SUMMARY OF THE INVENTION

However, in a filter (a honeycomb filter) described in Patent Document 1, when PM is burnt to regenerate a DPF as described above, especially a portion in the vicinity of deposited PM reaches a high temperature. Therefore, the filter described in Patent Document 1 might cause deterioration of a catalytic function or deterioration of a trapping efficiency in the portion which has reached the high temperature. Consequently, in a case where the above honeycomb filter continues to be used as it is, there is the fear that the honeycomb filter does not sufficiently perform a function of the filter. Alternatively, the DPF can periodically be changed. However, it is wasteful to change a DPF which has not caused the deterioration of the catalytic function or the deterioration of the trapping efficiency yet, and this change also requires a great deal of labor.

Thus, it is important to simply detect whether or not the honeycomb filter is exposed to the high temperature which causes the deterioration of the catalytic function or the deterioration of the trapping efficiency.

The present invention has been developed in view of the above-mentioned problem. An object of the present invention is to provide a honeycomb filter in which it is detectable that an inner portion has reached a high temperature and in which generation of end face cracks is inhibited.

[1] A honeycomb filter including a honeycomb structure body having porous partition walls defining a plurality of cells which extend from an inflow end face of one end face to an outflow end face of the other end face and become through channels for fluid, plugging portions disposed in open ends of the cells of the honeycomb structure body, and a protective layer disposed to cover at least the surface of the honeycomb structure body, wherein each of the honeycomb structure body and the plugging portion has a structure constituted of aggregates made of silicon carbide and a bonding material which bonds the aggregates to one another, the protective layer is a layer in which silicon is present as much as 40 mass % or more and oxygen is present as much as 40 mass % or more and a thickness is 0.5 μm or more, and an outer end face of both end faces of the plugging portion has an exposed region where the protective layer having the thickness of 0.5 μm or more is not disposed.

[2] The honeycomb filter according to the above [1], wherein the thickness of the protective layer is 1.0 μm or more.

[3] The honeycomb filter according to the above [1] or [2], wherein the thickness of the protective layer is from 1.0 to 6.0 μm.

[4] The honeycomb filter according to any one of the above [1] to [3], wherein the bonding material contains silicon or cordierite.

[5] The honeycomb filter according to any one of the above [1] to [4], which further includes a catalyst layer containing an oxidation catalyst or a reduction catalyst on the protective layer disposed on at least the surfaces of the partition walls.

In a honeycomb filter of the present invention, it is detectable that an inner portion has reached a high temperature, and generation of end face cracks is inhibited.

### BRIEF DESCRIPTION OF THE DRAWINGS

FIG. 1 is a perspective view schematically showing one embodiment of a honeycomb filter of the present invention;

FIG. 2 is a cross-sectional view schematically showing a cross section of the one embodiment of the honeycomb filter of the present invention which is parallel to a cell extending direction;

FIG. 3 is a plan view schematically showing an enlarged part of an outflow end face in the one embodiment of the honeycomb filter of the present invention; and

FIG. 4 is a plan view schematically showing an enlarged part of the outflow end face in the one embodiment of the honeycomb filter of the present invention.

### DESCRIPTION OF THE PREFERRED EMBODIMENTS

Hereinafter, embodiments of the present invention will specifically be described with reference to the drawings. The present invention is not limited to the following embodiments. It should be understood that the following embodiments to which modifications, improvements and the like are suitably added on the basis of ordinary knowledge of a person skilled in the art without departing from the gist of the present invention also fall in the scope of the present invention.

(1) Honeycomb Structure:

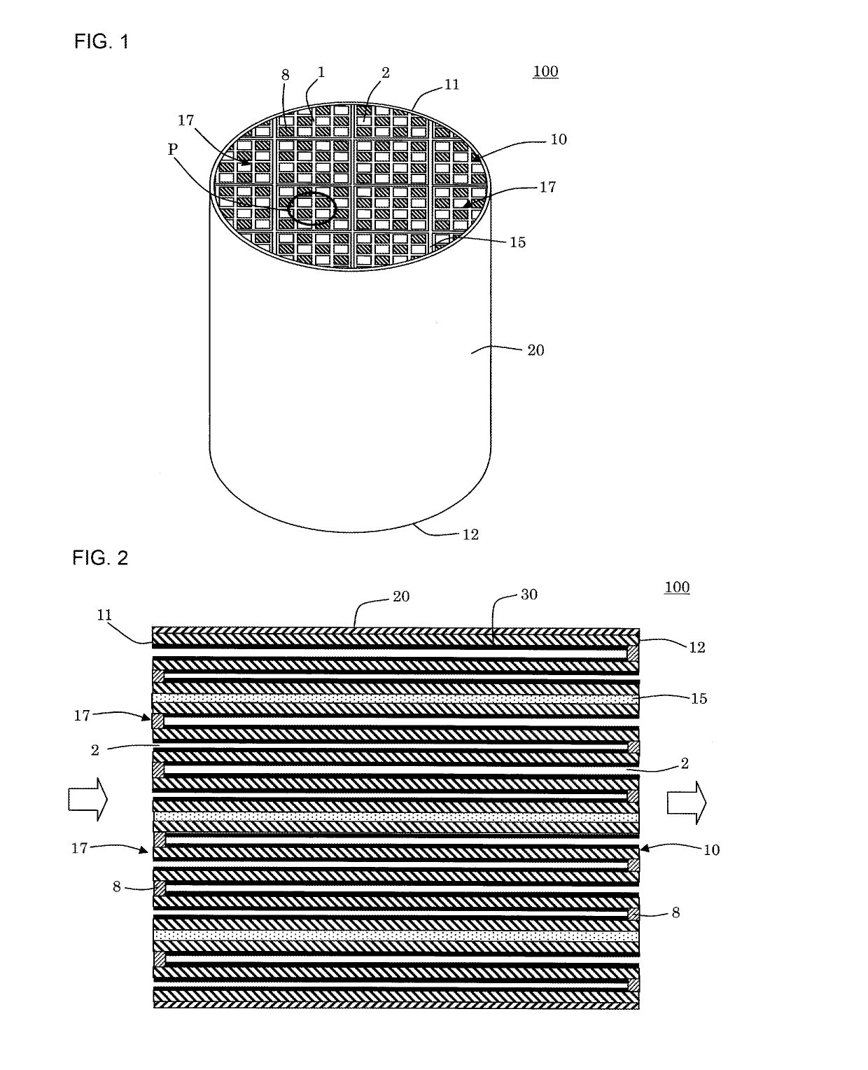

One embodiment of a honeycomb filter of the present invention is directed to a honeycomb filter 100 shown in FIG. 1 to FIG. 3. The honeycomb filter 100 includes a honeycomb structure body 10 having porous partition walls 1 defining a plurality of cells 2 which extend from an inflow end face 11 of one end face to an outflow end face 12 of the other end face and become through channels for fluid. Furthermore, the honeycomb filter 100 includes plugging portions 8 disposed in open ends of the cells 2 of the honeycomb structure body 10, and a protective layer 30 disposed to cover at least the surface of the honeycomb structure body 10. Each of the honeycomb structure body 10 and the plugging portion 8 has a structure constituted of aggregates made of silicon carbide and a bonding material which bonds the aggregates to one another. Furthermore, the protective layer 30 is a layer in which silicon is present as much as 40 mass % or more and oxygen is present as much as 40 mass % or more and a thickness is 0.5 μm or more. Furthermore, an outer end face of both end faces of the plugging portion 8 has an exposed region 33 in which the protective layer 30 is not disposed.

In the honeycomb filter 100, the exposed region 33 which does not have the protective layer 30 is present in the surface of the plugging portion 8, and hence it is detectable that an inner portion has reached a high temperature. Furthermore, in the honeycomb filter 100, there is the exposed region 33 where the protective layer 30 is not present in the surface of the plugging portion 8, so that a thermal conductivity and a thermal expansion coefficient in this portion improve and generation of end face cracks is inhibited.

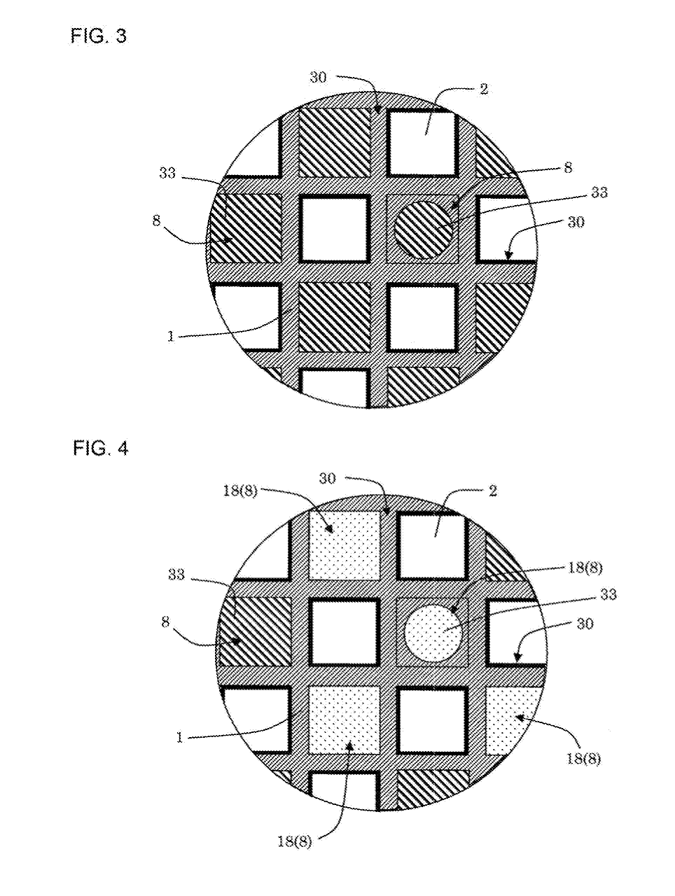

FIG. 1 is a perspective view schematically showing one embodiment of the honeycomb filter of the present invention. FIG. 2 is a cross-sectional view schematically showing a cross section of the one embodiment of the honeycomb filter of the present invention which is parallel to a cell extending direction. FIG. 3 is a plan view schematically showing an enlarged region P (see FIG. 1) which is a part of the outflow end face in the one embodiment of the honeycomb filter of the present invention.

(1-1) Protective Layer:

The protective layer is the layer in which silicon is present as much as 40 mass % or more and oxygen is present as much as 40 mass % or more and the thickness is 0.5 μm or more. This protective layer means a film of silicon dioxide which is formed on the surface of silicon-silicon carbide when manufacturing the honeycomb filter by use of a silicon-silicon carbide based composite material, and the film has the thickness of 0.5 μm or more. When the protective layer is a film (a layer) whose thickness is smaller than 0.5 μm, it is not possible to sufficiently prevent fiber formation when the honeycomb filter is exposed to the high temperature.

“The fiber formation” indicates that a white fibrous substance made of silicon carbide (SiO₂) is generated on the surface of the honeycomb structure body or each plugging portion. Specifically, in a case where the protective layer is not disposed and when the honeycomb filter is exposed to the high temperature, a gas of silicon monoxide (SiO) volatilizes from the partition walls or the plugging portions of the honeycomb filter as shown in Equations (1) and (2) mentioned below. Afterward, the generated SiO gas combines with oxygen in an atmosphere, the fibrous substance of SiO₂ is generated, and this substance precipitates on the surface of the honeycomb structure body or the plugging portion. Such a phenomenon is called the fiber formation or whitening. It is to be noted that Equation (2) indicates a case where silicon is used as the bonding material.

SiC(solid)+O₂(gas)=SiO(gas)+CO(gas) (1)

Si(solid)+O₂(gas)=SiO(gas)+1/2O₂(gas) (2)

Furthermore, it is judged whether or not the layer is “the protective layer” as follows. First, the honeycomb structure body 10 is measured with FE-EPMA (a field emission type electron probe microanalyzer), and there is confirmed presence/absence of the layer in which silicon is present as much as 40 mass % or more and oxygen is present as much as 40 mass % or more and which covers SiC particles. Afterward, in a case where the thickness of the layer is 0.5 μm or more in the measurement with the FE-EPMA, it is judged that the layer is “the protective layer”.

The thickness of the protective layer of the honeycomb structure body 10 is preferably 1.0 μm or more and further preferably from 1.0 to 6.0 μm. In this range, reactions of Equations (1) and (2) mentioned above can noticeably be inhibited, and the fiber formation can be prevented. It is to be noted that the thickness of the protective layer is a value measured as follows. In the measurement with the FE-EPMA, five regions of a viewing field having a vertical size of 100 μm and a horizontal size of 100 μm are randomly extracted from the honeycomb structure body 10. Then, from each viewing field, there are randomly extracted 10 regions of the layer in which silicon is present as much as 40 mass % or more and oxygen is present as much as 40 mass % or more and which covers the SiC particles, to measure thicknesses of the regions. An average value of the thicknesses of the 50 regions in total is obtained as the thickness of the protective layer.

(1-2) Plugging Portion:

The plugging portion has, in its outer end face, the exposed region where the protective layer is not disposed. The honeycomb filter has the exposed region in this manner, and hence when the honeycomb filter is exposed to the high temperature, the fiber formation occurs in this exposed region. Therefore, in the present invention, it can simply visually be confirmed whether the inner portion of the honeycomb filter is exposed to the high temperature. FIG. 4 shows a state where the fiber formation occurs in the exposed region 33 of the surface of the plugging portion 8 when the honeycomb filter is exposed to the high temperature. The region where the fiber formation occurs is shown by dots, and a region where the fiber formation does not occur is shown by slant lines. FIG. 4 is a plan view schematically showing an enlarged part of the outflow end face in the one embodiment of the honeycomb filter of the present invention.

It is to be noted that “the outer end face” in the plugging portion is an end face on an apparently visible side in both the end faces of the plugging portion when the honeycomb filter is seen.

The exposed region in the plugging portion may be the whole region of each plugging portion 8 or a part of the plugging portion as shown in a part of FIG. 3.

Furthermore, the plugging portions each having the exposed region may be all the plugging portions that are disposed or parts of the plugging portions. That is, a central portion of the honeycomb filter is easier to be exposed to the high temperature as compared with a circumferential portion thereof, and hence it may be defined that the plugging portions disposed in the central portion of the honeycomb filter only have the exposed region, whereas the plugging portions disposed in the circumferential portion do not have any exposed regions.

It is to be noted that the plugging portion having the exposed region is preferably the plugging portion disposed on an outflow end face side of the honeycomb structure body. Consequently, when the honeycomb filter is canned in a can member and mounted in a car, it is easily confirmed whether or not the honeycomb filter is exposed to the high temperature.

(1-3) Honeycomb Structure Body:

The honeycomb structure body 10 has the porous partition walls 1 defining the plurality of cells 2 which extend from the inflow end face 11 to the outflow end face 12 and become the through channels for the fluid as described above, and the surface of each partition wall 1 is covered with the protective layer 30. Furthermore, the partition walls of the honeycomb structure body have the structure constituted of the aggregates made of silicon carbide (SiC) and the bonding material (Si, cordierite or the like) which bonds the aggregates to one another.

The honeycomb structure body of the honeycomb filter of the present invention may be constituted of a bonded body in which a plurality of honeycomb segments are bonded to one another by a bonding layer. That is, as shown in FIG. 1, the honeycomb structure body 10 may be constituted of a bonded body including a plurality of honeycomb segments 17 and a bonding layer 15 which bonds the honeycomb segments 17 to one another. The honeycomb segment 17 includes a cell structure body having a plurality of cells 2 defined by porous partition walls 1, and an outer wall disposed at a circumference of the cell structure body.

It is preferable that the bonding material constituting the partition walls 1 contains silicon or cordierite. In a case where the bonding material contains silicon, the thermal conductivity of the partition walls 1 increases, and hence the honeycomb structure body 10 is capable of suppressing a temperature during PM regeneration. Furthermore, in a case where the bonding material contains cordierite, the thermal expansion coefficient of the partition walls 1 decreases, and hence cracks are hard to be generated.

A thickness of the partition walls 1 is preferably from 50 to 500 μm and especially preferably from 100 to 400 μm. When the thickness of the partition walls 1 is smaller than a lower limit value, a strength decreases, and hence there is the fear that the cracks are easily generated. When the thickness is in excess of an upper limit value, a resistance of an exhaust gas passing through the partition walls increases, and hence there is the fear that a pressure loss increases.

There is not any special restriction on a cell density of the honeycomb structure body 10. The cell density of the honeycomb structure body 10 is preferably from 15 to 650 cells/cm² and especially preferably from 30 to 550 cells/cm². When the cell density is smaller than a lower limit value, a filtration area decreases, and hence there is the fear that the pressure loss increases when the PM is deposited. When the cell density is in excess of an upper limit value, a distance between the partition walls decreases, and hence there is the fear that the through channels (the cells) are clogged with the PM.

There is not any special restriction on a cell shape of the honeycomb structure body 10 (the cell shape in a cross section perpendicular to the cell extending direction). Examples of the cell shape include a triangular shape, a quadrangular shape, a hexagonal shape, an octagonal shape, a round shape, and any combination of these shapes. In the quadrangular shape, a square shape or a rectangular shape is preferable.

There is not any special restriction on a shape of the honeycomb structure body 10. It is preferable that the shape of the honeycomb structure body 10 is a round pillar shape, a pillar shape in which each end face is elliptic, or a pillar shape in which each end face has a polygonal shape such as “a square shape, a rectangular shape, a triangular shape, a pentangular shape, a hexagonal shape, or an octagonal shape”. In the honeycomb filter 100 shown in FIG. 1, the shape of the honeycomb structure body 10 is the round pillar shape.

In the honeycomb structure body 10, a circumference coating layer 20 may be formed. A thickness of the circumference coating layer 20 is preferably from 0.05 to 3.0 mm and further preferably from 0.1 to 1.5 mm. When the thickness of the circumference coating layer 20 is smaller than a lower limit value, a strength of the circumferential portion runs short, and hence there is the fear that the circumferential portion is easily broken. When the thickness is in excess of an upper limit value, the filtration area decreases, and hence there is the fear that the pressure loss increases.

(1-4) Catalyst Layer:

It is preferable that the honeycomb filter of the present invention further includes a catalyst layer containing an oxidation catalyst or a reduction catalyst on the protective layer disposed on at least the surfaces of the partition walls.

There is not any special restriction on a thickness of the catalyst layer, and a thickness of a heretofore known catalyst layer is suitably employable.

(2) Manufacturing Method of Honeycomb Filter:

The honeycomb filter of the present invention can be manufactured by the following method. That is, the honeycomb filter of the present invention can be manufactured by a method having a honeycomb segment preparation step, a plugged honeycomb segment preparation step, and a bonded body preparation step. The honeycomb segment preparation step is a step of firing a honeycomb formed body to prepare the honeycomb structure (a honeycomb fired body). The plugged honeycomb segment preparation step is a step of charging a plugging slurry into predetermined cells of the honeycomb segment prepared in the honeycomb segment preparation step to prepare the honeycomb segment including the plugging portions (a plugged honeycomb segment). The bonded body preparation step is a step of bonding the plugged honeycomb segments to one another by use of a bonding material to prepare the bonded body. It is to be noted that “the honeycomb segment” has a plurality of porous partition walls defining a plurality of cells which extend from an inflow end face of one end face to an outflow end face of the other end face and become through channels for fluid.

Hereinafter, a manufacturing method of the honeycomb filter of the present invention will be described every step.

(2-1) Honeycomb Segment Preparation Step:

The honeycomb segment can be prepared by using a heretofore known method. More specifically, to a material of the honeycomb segment containing silicon carbide and a bonding material, a binder, a pore former, a surfactant, water as a liquid medium and the like are added and kneaded to prepare a kneaded material having a plasticity, and the prepared kneaded material is formed into a pillar-shaped body and dried. Examples of the binder include methylcellulose, hydroxypropoxyl cellulose, hydroxyethylcellulose, hydroxypropoxyl methylcellulose, carboxymethylcellulose, and polyvinyl alcohol. Afterward, firing and an oxidation treatment are performed. The honeycomb segment can be prepared by this method.

There is not any special restriction on a kneading method, a method of forming the prepared kneaded material into the pillar-shaped body, and a drying method. An example of the kneading method is a method of using a kneader, a vacuum pugmill or the like. Furthermore, as the method of forming the prepared kneaded material into the pillar-shaped body, a heretofore known forming method such as extrusion, injection molding or press molding is usable. Among these methods, a preferable method is a method of extruding the prepared kneaded material by use of a honeycomb segment forming die to obtain a desirable outer wall thickness, partition wall thickness or cell density. Furthermore, as the drying method, there is usable a heretofore known drying method such as hot air drying, microwave drying, induction drying, reduced pressure drying, vacuum drying or freeze drying. Among these methods, it is preferable to use the drying method in which the hot air drying is combined with the microwave drying or the induction drying, because the whole honeycomb segment can rapidly and uniformly be dried.

An example of a firing method is a method of performing the firing in a firing furnace. The firing furnace and firing conditions are suitably selectable in accordance with the shape, material or the like of the honeycomb segment. Prior to the firing, an organic substance such as the binder may be burnt and removed by calcinating.

The oxidation treatment can be performed by a heretofore known method. Specifically, there is employable a method of heating the fired honeycomb segment containing silicon carbide at 900 to 1400° C. under an oxygen atmosphere (e.g., an oxygen concentration of 15 to 20 mass %) to oxidize a part of silicon carbide constituting the honeycomb segment.

(2-2) Plugged Honeycomb Segment Preparation Step:

In the present step, the plugging slurry is charged into the predetermined cells of the honeycomb segment prepared in the honeycomb segment preparation step, to prepare the honeycomb segment including the plugging portions (the plugged honeycomb segment).

As the method of plugging the cells, a heretofore known method is usable. More specifically, there is usable a method of attaching a sheet to an end face of the honeycomb segment, and then making holes at positions of this sheet which correspond to the cells to be plugged. The method further includes immersing, into the plugging slurry, the end face to which the sheet is attached, charging the plugging slurry into the open ends of the cells to be plugged through the holes made in the sheet, and drying and firing the slurry. It is to be noted that a material of the plugging slurry contains silicon carbide. By use of the material containing silicon carbide in this manner, the fiber formation might occur in this plugging portion when the plugging portion is exposed to the high temperature. In the present invention, the fiber formation is confirmed, whereby it is detectable that the honeycomb filter is exposed to the high temperature.

It is to be noted that in the present invention, the plugging portion is required to have the exposed region where the protective layer is not formed on the surface, and hence it is preferable that the oxidation treatment is not performed after the plugging portion is formed. However, it is possible to further perform the oxidation treatment to such an extent that the protective layer (i.e., the layer in which silicon is present as much as 40 mass % or more and oxygen is present as much as 40 mass % or more and the thickness is 0.5 μm or more) is not formed on the surface of the plugging portion.

(2-3) Bonded Body Preparation Step:

In the present step, the plugged honeycomb segments are bonded to one another by use of a bonding slurry to prepare the bonded body. As the bonding slurry, a heretofore known slurry is suitably employable.

(2-4) Another Step:

A circumferential portion of the bonded body can be cut into a desirable circumferential shape. There is not any special restriction on a cutting method, and a heretofore known method is usable.

A circumference of the bonded body whose circumferential portion is cut as described above may be coated with a circumference coating material to form a circumference coating layer. In this way, the honeycomb filter with the circumference coating layer is obtainable. By forming the circumference coating layer, the honeycomb filter can be prevented from being broken when an external force is applied to the honeycomb filter.

An example of the circumference coating material is a material obtained by adding additives such as an organic binder, a foamable resin and a dispersing agent to inorganic raw materials such as an inorganic fiber, colloidal silica, clay and SiC particles and further adding water, followed by kneading. An example of a coating method with the circumference coating material is a method of coating “the cut bonded body” with the material by use of a rubber spatula or the like while rotating the cut bonded body on a potter's wheel.

Furthermore, when the honeycomb filter with the circumference coating layer is immersed into a slurry for the catalyst, the catalyst can be loaded onto the surfaces of the partition walls of the honeycomb filter with the circumference coating layer.

### EXAMPLES

Hereinafter, the present invention will more specifically be described with reference to examples. The present invention is not limited to these examples.

### Example 1

As a material of a honeycomb segment, there was used a mixture obtained by mixing SiC powder and metal Si powder at a mass ratio of 80:20. Then, to this mixture, starch and a foamable resin were added as a pore former, and methylcellulose, hydroxypropoxyl methylcellulose, a surfactant and water were further added and kneaded to prepare a kneaded material having a plasticity.

Next, the prepared kneaded material was extruded, dried, fired and then subjected to an oxidation treatment to obtain a prismatic columnar honeycomb segment. Additionally, a protective layer was formed on the surface of this prismatic columnar honeycomb segment. Afterward, a plugging slurry was charged into predetermined cells of the obtained prismatic columnar honeycomb segment, and this segment was dried to obtain a plugged prismatic columnar honeycomb segment.

Furthermore, as the plugging slurry, the same material as in the kneaded material was employed. Plugging portions were arranged so that one end face and the other end face possessed complementary checkerboard patterns. Furthermore, in the prismatic columnar honeycomb segment, a cell density was 46 cells/cm² and a thickness of partition walls was 320 μm.

Next, 16 obtained plugged prismatic columnar honeycomb segments were arranged in 4×4 and assembled by coating respective outer walls with a pasted bonding material, and then pressurized from four directions. Afterward, the bonding material was dried to obtain a bonded body. Then, a circumferential portion of this bonded body was cut so that its outer shape was a round pillar shape, and a circumferential surface was then coated with a circumference coating material to prepare a round pillar-shaped honeycomb filter.

In the obtained honeycomb filter, a diameter of a cross section perpendicular to a cell extending direction was 144 mm, and a length in the cell extending direction was 152 mm. Furthermore, in the honeycomb filter, a thickness of a bonding layer was 1.0 mm.

In a honeycomb structure body of the obtained honeycomb filter, there was formed the protective layer in which silicon was present as much as 49 mass % and oxygen was present as much as 42 mass % and a thickness was 1.5 μm. Furthermore, in this honeycomb filter, the protective layer was not formed on the surfaces of the plugging portions (the surfaces on an outflow end face side of the honeycomb structure body).

Additionally, as to presence/absence of the protective layer, presence/absence of a layer made of silicon and oxygen around silicon carbide particles was confirmed with FE-EPMA (a field emission type electron probe microanalyzer), and in a case where this layer was confirmed, it was judged that the protective layer was “present”. Additionally, mass concentrations (mass %) of silicon and oxygen in the protective layer and the thickness of the protective layer were also measured with the FE-EPMA.

As to the honeycomb filter, respective evaluations of “high temperature detection”, “an end face crack limit”, “presence/absence of fiber formation of the honeycomb structure body” and “general judgment” were perfoiiiied by methods mentioned below. Table 1 shows the results.

TABLE 1

| | Structure | | | | | | | | | | | | | |
|---|---|---|---|---|---|---|---|---|---|---|---|---|---|---|
| | | | Protective layer of honeycomb structure | | | | | | Performance survey result | | | | | |
| | | Catalyst | body | | | Protective layer of plugging portion | | | High temperature | | End face crack limit | | Presence/absence | |
| | Bonding | layer | Silicon | Oxygen | | Silicon | Oxygen | | detection | | Amount of | | of fiber formation | |
| | material | Presence/ | Mass | Mass | | Mass | Mass | | No. of | | deposited | | of honeycomb | General |
| | Type | absence | concentration | concentration | Thickness | concentration | concentration | Thickness | persons | Judgment | PM | Judgment | structure body | judgment |
| Example 1 | Silicon | None | 49% | 42% | 1.5 μm | — | — | None | 5 persons | A | +1.0 g/L | A | None (1400° C.) | OK |
| Example 2 | Silicon | None | 51% | 43% | 0.5 μm | — | — | None | 5 persons | A | +1.0 g/L | A | None (1350° C.) | OK |
| Example 3 | Silicon | None | 53% | 46% | 1.0 μm | — | — | None | 5 persons | A | +1.0 g/L | A | None (1400° C.) | OK |
| Example 4 | Silicon | None | 53% | 46% | 1.5 μm | — | — | None | 5 persons | A | +1.0 g/L | A | None (1400° C.) | OK |
| Example 5 | Silicon | None | 53% | 46% | 1.5 μm | 51% | 43% | 0.3 μm | 3 persons | B | +1.0 g/L | A | None (1400° C.) | OK |
| Example 6 | Silicon | None | 53% | 46% | 3.0 μm | — | — | None | 5 persons | A | +1.0 g/L | A | None (1400° C.) | OK |
| Example 7 | Silicon | None | 53% | 46% | 6.0 μm | — | — | None | 5 persons | A | +1.0 g/L | A | None (1400° C.) | OK |
| Example 8 | Silicon | None | 53% | 46% | 7.0 μm | — | — | None | 5 persons | A | +0.5 g/L | B | None (1400° C.) | OK |
| Example 9 | Silicon | Present | 53% | 46% | 1.0 μm | — | — | None | 5 persons | A | +1.0 g/L | A | None (1400° C.) | OK |
| Example 10 | Cordierite | None | 53% | 46% | 1.0 μm | — | — | None | 5 persons | A | +1.0 g/L | A | None (1400° C.) | OK |
| Example 11 | Cordierite | Present | 53% | 46% | 1.5 μm | — | — | None | 5 persons | A | +1.0 g/L | A | None (1400° C.) | OK |
| Comparative | Silicon | None | 53% | 46% | 1.5 μm | 53% | 46% | 1.5 μm | 0 person | C | base | — | None (1400° C.) | NG |
| Example 1 | | | | | | | | | | | | | | |
| Comparative | Silicon | None | 37% | 32% | 1.0 μm | — | — | None | 5 persons | A | +1.0 g/L | A | Present | NG |
| Example 2 | | | | | | | | | | | | | | |
| Comparative | Silicon | None | 51% | 43% | 0.3 μm | — | — | None | 5 persons | A | +1.0 g/L | A | Present | NG |
| Example 3 | | | | | | | | | | | | | | |
| Comparative | Silicon | None | 53% | 46% | 1.0 μm | 53% | 46% | 1.0 μm | 0 person | C | ±0 g/L | C | None (1400° C.) | NG |
| Example 4 | | | | | | | | | | | | | | |
| Comparative | Silicon | None | — | — | None | — | — | None | 5 persons | A | ±0 g/L | C | Present | NG |
| Example 5 | | | | | | | | | | | | | | |
| Comparative | Silicon | None | 53% | 46% | 1.0 μm | 51% | 43% | 0.5 μm | 1 person | C | +0.5 g/L | B | None (1400° C.) | NG |
| Example 6 | | | | | | | | | | | | | | |
| Comparative | Silicon | Present | 53% | 46% | 1.0 μm | 53% | 46% | 1.0 μm | 0 person | C | ±0 g/L | C | None (1400° C.) | NG |
| Example 7 | | | | | | | | | | | | | | |
| Comparative | Silicon | Present | — | — | None | — | — | None | 5 persons | A | ±0 g/L | C | Present | NG |
| Example 8 | | | | | | | | | | | | | | |
| Comparative | Cordierite | None | — | — | None | — | — | None | 5 persons | A | +1.0 g/L | A | Present | NG |
| Example 9 | | | | | | | | | | | | | | |
| Comparative | Cordierite | Present | — | — | None | — | — | None | 5 persons | A | +1.0 g/L | A | Present | NG |
| Example 10 | | | | | | | | | | | | | | |

(High Temperature Detection)

First, an exhaust gas emitted from a diesel engine (3.0 liters, a direct injection common rail, and 6 cylinders in series) flowed into the honeycomb filter, and soot was deposited in the honeycomb filter at a rate of 6 g/L. Afterward, an oxidation catalyst was disposed in an exhaust system of the diesel engine (3.0 liters, the direct injection common rail, and 6 cylinders in series), and the honeycomb filter was disposed on a downstream of the exhaust system. An operation was performed at an engine rotation number of 2000 rpm and a torque of 178 N·m to carry out post injection, and after a temperature at which the exhaust gas flowed into the honeycomb filter reached 600° C., the operation fell in an idle state to carry out forced regeneration. A plurality of honeycomb filters was prepared, and the above operation was repeated until the following two honeycomb filters were obtained. Specifically, an amount of the soot to be deposited in the honeycomb filter was increased to repeat the operation until there were obtained two honeycomb filters, i.e., the honeycomb filter in which a temperature reached 1350° C. or higher and lower than 1400° C. and the honeycomb filter in which the temperature reached 1400° C. or higher and lower than 1450° C.

Afterward, as to the honeycomb filter in which the temperature reached 1350° C. or higher and lower than 1400° C., the soot on the outflow end face was removed, and five observer persons were prepared to observe the outflow end face. In a case where the number of persons who recognize that there is a brighter portion as compared with color prior to a test is one or less, evaluation is “C (it is difficult to detect exposure to a high temperature)”, in a case where the number of the persons is two or more and four or less, the evaluation is “B (it is detectable)”, and in a case where all the five persons recognize that, the evaluation is “A (it is easily detectable)”. In a case where there is the brighter portion as compared with the color prior to the test, it can be judged that fiber formation occurs to cause whitening, and hence the exposure to the high temperature is detectable. On the other hand, in a case where the whitening is not observed, it can be judged that the exposure to the high temperature is not detectable.

(End Face Crack Limit)

The end face crack limit was confirmed by visually observing the end face of the honeycomb filter when the above test of “the high temperature detection” was performed. The evaluation was performed on the basis of the honeycomb filter of Comparative Example 1 as a standard. For example, Table 1 shows “+1 g/L” which is the result indicating that the amount of the PM to be deposited at which cracks are generated in the end face is 1 g/L larger than that in Comparative Example 1.

In a case where the amount of the PM to be deposited at which the cracks are generated in the end face is larger than that in Comparative Example 1 as much as 1 g/L or more, evaluation is “A”. In a case where the amount of the PM to be deposited at which the cracks are generated in the end face is larger than that in Comparative Example 1 as much as 0.5 g/L or more and smaller than 1 g/L, the evaluation is “B”. In a case where the amount of the PM to be deposited at which the cracks are generated in the end face is larger than that in Comparative Example 1 as much as an amount smaller than 0.5 g/L, the evaluation is “C”.

(Presence/Absence of Fiber Formation of Honeycomb Structure Body)

The above test of “the high temperature detection” was performed, and then presence/absence of the whitening (i.e., a white fiber) was observed with a microscope to carry out evaluation on the basis of evaluation standards similar to those in this “high temperature detection” test. In a case where the fiber was observed in the honeycomb structure body of the honeycomb filter in which the temperature reached 1350° C. or higher and lower than 1400° C., it was judged that the fiber formation was “present”. In a case where the fiber was not observed in the honeycomb filter in which the temperature reached 1400° C. or higher and lower than 1450° C., it was judged that the fiber formation was “none (1400° C)”. In a case where the fiber was observed in the honeycomb filter in which the temperature reached 1400° C. or higher and lower than 1450° C., but the fiber was not observed in the honeycomb filter in which the temperature reached 1350° C. or higher and lower than 1400° C., it was judged that the fiber formation was “none (1350° C)”.

(General Judgment)

In a case where the result of the high temperature detection was not “C”, the result of the end face crack limit was not “C” and furthermore, the presence/absence of the fiber formation of the honeycomb structure body was not the presence, judgment was “OK”, and in a case other than the above case, the judgment was “NG”.

### Examples 2 to 11 and Comparative Examples 1 to 10

The procedure of Example 1 was repeated except that conditions were changed as shown in Table 1, to obtain honeycomb filters. As to the obtained honeycomb filters, respective evaluations of “high temperature detection”, “an end face crack limit”, “presence/absence of fiber formation of a honeycomb structure body” and “general judgment” were performed. Table 1 shows the results.

In each of Comparative Examples 1 and 4, protective layers were disposed in both of the honeycomb structure body and each plugging portion by a heretofore known method. Specifically, a kneaded material was extruded and dried to obtain a honeycomb formed body, and a plugging slurry was charged into predetermined cells of the honeycomb formed body, fired and then subjected to an oxidation treatment, thereby disposing the protective layers in both of the honeycomb structure body and the plugging portion.

Furthermore, in Example 5, for the purpose of forming thin films also in the plugging portions, the procedure of Example 1 was repeated to charge a plugging slurry into predetermined cells and further perform an oxidation treatment.

It has been found from Table 1 that in the honeycomb filters of Examples 1 to 11, as compared with the honeycomb filters of Comparative Examples 1 to 10, it is detectable that each inner portion has reached a high temperature, and generation of end face cracks is inhibited.

A honeycomb filter of the present invention is suitably utilizable as a filter to purify an exhaust gas of a car or the like.

### DESCRIPTION OF REFERENCE NUMERALS

1: partition wall, 2: cell, 10: honeycomb structure body, 11: inflow end face, 12: outflow end face, 8: plugging portion, 15: bonding layer, 17: honeycomb segment, 18: the surface of the plugging portion in which fiber formation occurs, 20: circumference coating layer, 30: protective layer, 33: exposed region, 100: honeycomb filter, and P: region.

What is claimed is:

1. A honeycomb filter comprising:
a honeycomb structure body having porous partition walls defining a plurality of cells which extend from an inflow end face of one end face to an outflow end face of the other end face and become through channels for fluid;
plugging portions disposed in open ends of the cells of the honeycomb structure body; and
a protective layer disposed to cover at least the surface of the honeycomb structure body,
wherein each of the honeycomb structure body and the plugging portion has a structure constituted of aggregates made of silicon carbide and a bonding material which bonds the aggregates to one another,
the protective layer is a layer in which silicon is present as much as 40 mass % or more and oxygen is present as much as 40 mass % or more and a thickness is 0.5 μm or more, and
an outer end face of both end faces of the plugging portion has an exposed region where the protective layer having the thickness of 0.5 μm or more is not disposed.

2. The honeycomb filter according to claim 1,
wherein the thickness of the protective layer is 1.0 μm or more.

3. The honeycomb filter according to claim 1,
wherein the thickness of the protective layer is from 1.0 to 6.0 μm.

4. The honeycomb filter according to claim 1,
wherein the bonding material contains silicon or cordierite.

5. The honeycomb filter according to claim 1,
which further comprises a catalyst layer containing an oxidation catalyst or a reduction catalyst on the protective layer disposed on at least the surfaces of the partition walls.
